(19) United States
(12) Patent Application Publication
(10) Pub. No.: US 2012/0272083 A1
(43) Pub. Date: Oct. 25, 2012

(54) IMAGE PROCESSING APPARATUS, CONTROL METHOD THEREFOR, AND STORAGE MEDIUM

(75) Inventor: Minoru FUJISAWA, Machida-shi (JP)

(73) Assignee: CANON KABUSHIKI KAISHA, Tokyo (JP)

(21) Appl. No.: 13/452,188

(22) Filed: Apr. 20, 2012

(30) Foreign Application Priority Data
Apr. 21, 2011 (JP) 2011-095279

(51) Int. Cl. G06F 1/00

(52) U.S. Cl. 713/323

(57) ABSTRACT

An image processing apparatus and a control method therefor are provided, which realize security communication in a power saving mode while suitably maintaining the power saving mode, even if a control unit operating in the power saving mode has fewer resources than a control unit operating in a normal power mode. To accomplish this, the image processing apparatus stores a plurality of security information pieces regarding a security communication, selects a security information piece to be notified to the network interface apparatus from among the security information pieces, and notifies the network interface apparatus of the selected security information piece. The network interface apparatus executes security communication using the notified security information piece, when the image processing apparatus operates in the power saving mode.

### BACKGROUND OF THE INVENTION

1. Field of the Invention

The present invention relates to an image processing apparatus that performs power control, a control method therefor, and a storage medium.

2. Description of the Related Art

In recent years, in order to reduce power consumed by devices, a power saving function for causing devices to shift to a “sleep state (power saving mode)”, in which the devices can operate at low power due to a limited supply of power to only parts of the devices, if a certain period of time has elapsed since the devices had entered a non-operating state has been advanced. Also, due to the spread of network technology, a situation can be considered in which data is periodically exchanged between devices and hosts using networks. In order for devices in the “sleep state” to perform data processing via networks, the devices need to be shifted to a “non-sleep state (normal power mode)”. As a result, in an environment in which data is frequently exchanged on networks, the “sleep state” time is shortened and power consumption cannot be reduced effectively.

As a technique for solving this problem, conventional technology has proposed a technique in which a plurality of CPUs are mounted on a device, and a main CPU is used for processing in the non-sleep state, whereas a sub CPU, which consumes lower power, is used for processing in the sleep state as a proxy of the main CPU, thereby reducing reversion from the sleep state. Furthermore, a technique for providing a sub CPU with protocol stacks is also considered in order to expand processing that can be processed by the sub CPU as a proxy due to the diversity and complexity of network protocols.

On the other hand, with the recent spread of security functions for preventing tampering and tapping of data on networks, devices employ a system that involves complex negotiations with communication parties and encryption/decoding processing based on the results of negotiations. Following this, opportunities for using security communication to exchange network data, which is periodically exchanged between devices and hosts, are also increasing. Japanese Patent Laid-Open No. 2006-191537 proposes a method that allows a sub CPU to serve as a proxy of the main CPU even during security communication, by equipping the sub CPU with a security function and exchanging information necessary for security communication between the main CPU and the sub CPU.

However, the conventional technology has the following problems. In general, it is difficult for embedded software products or the like to constitute rich resources, such as RAM regions, on both the main CPU side and the sub CPU side due to the limitation of parts cost or the like. In particular, the area of resources used on the sub CPU side where power consumption is low will be smaller than the area of resources used on the main CPU side, in consideration of the fact that the sub CPU operates in the power saving state. Accordingly, a situation arises in which all security communication information pieces to be exchanged between the main CPU and the sub CPU cannot be passed.

For example, in the case where information pieces held on the main CPU side, the number of which corresponding to the number of security communication sessions, are passed to the sub CPU side, there is the problem that the information pieces corresponding to all the communication sessions cannot be passed due to a small information storage area on the sub CPU side. In this case, only part of the security communication session information held on the main CPU side will be passed to the sub CPU side. For this reason, in the power saving mode, if data from an external apparatus is received using a security communication session that is not held on the sub CPU side, the data cannot be processed on the sub CPU side. As a result, the main CPU that manages all the security communication session information will revert from the power saving state and perform processing, which results in difficulty in maintaining the power saving state for a prolonged period of time.

### SUMMARY OF THE INVENTION

The present invention enables realization of an image processing apparatus, a control method therefor, and a storage medium that realize security communication in a power saving mode while suitably maintaining the power saving mode, even if a control unit operating in the power saving mode has fewer resources than a control unit operating in a normal power mode.

One aspect of the present invention provides an image processing apparatus connected to a network via a network interface apparatus and capable of operating in either a first power mode or a second power mode in which power consumption is lower than in the first power mode, comprising: a storage unit that stores a plurality of security information pieces regarding a security communication; a selection unit that selects a security information piece to be notified to the network interface apparatus, from among the plurality of security information pieces; and a notification unit that notifies the network interface apparatus of the security information piece selected by the selection unit, wherein when the image processing apparatus operates in the second power mode, the network interface apparatus executes the security communication using the security information piece notified from the notification unit.

Another aspect of the present invention provides a control method for an image processing apparatus that is connected to a network via a network interface apparatus, is capable of operating in either a first power mode or a second mode in which power consumption is lower than in the first power mode, and includes a storage unit that stores a plurality of security information pieces regarding a security communication, the method comprising: selecting a security information piece to be notified to the network interface apparatus, from among the plurality of security information pieces; and notifying the network interface apparatus of the security information piece selected in the selection step, wherein when the image processing apparatus operates in the second power mode, the network interface apparatus executes the security communication using the security information piece notified in the notification step.

Further features of the present invention will be apparent from the following description of exemplary embodiments with reference to the attached drawings.

### BRIEF DESCRIPTION OF THE DRAWINGS

FIG. 1 shows an exemplary configuration of the entire system including an image processing apparatus 101.

FIG. 2 is a block diagram showing a hardware configuration of the image processing apparatus 101.

FIG. 3 is a block diagram showing a software configuration of the image processing apparatus 101.

FIG. 4 shows detailed information in an SAD.

FIG. 5 is a flowchart showing the procedure of processing performed by a system control unit 210 when shifting to a sleep state.

FIG. 6 shows an SA selection table used as the basis for performing SA selection processing.

FIG. 7 is a flowchart showing the detailed procedure of the SA selection processing.

FIG. 8 is a flowchart showing the procedure for receiving/transmitting SA and updating the SA selection table when reverting from the sleep state.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

System Configuration

The present embodiment will describe processing performed in the case where an image processing apparatus executes encrypted communication. Note that the case in which communication is carried out using IPsec (Internet Protocol Security) is described here as an example of the encrypted communication. However, the present invention may apply other encrypted communication. IPsec is a protocol for preventing tampering and tapping of data on networks, using a specific authentication or encryption algorithm. IPsec is constituted by two protocols, Authentication Header (AH) and Encapsulations Security Payload (ESP), AH handling only authentication and ESP handling both authentication and encryption. Which protocol to use and the type of the authentication or encryption algorithm to be used in that case are determined through negotiations conducted before the start of IPsec communication. It is also defined that a key to be used in the encryption algorithm be exchanged between communication terminals before the start of IPsec communication, using Internet Key Exchange (IKE). Details of IPsec including the packet format and IKE are defined in Request For Comments (RFCs).

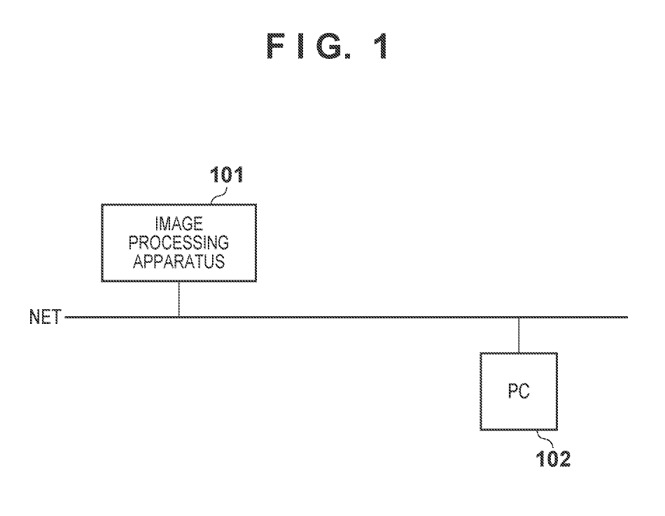

First, an exemplary configuration of the entire system including an image processing apparatus 101 will be described with reference to FIG. 1. In this image processing system, the image processing apparatus 101 and a PC 102 are connected via a network such that bidirectional communication is possible. It is assumed here that the image processing apparatus 101 and the PC 102 each have a configuration for executing IPsec communication, and IPsec is applied to all communications between the image processing apparatus 101 and the PC 102. Note that although the image processing system including a single image processing apparatus and a single PC is described here as an example, the present invention is not limited to this and can also be applied to an image processing system in which a plurality of image processing apparatuses and a plurality of PCs are connected to one another.

Hardware Configuration of Image Processing Apparatus

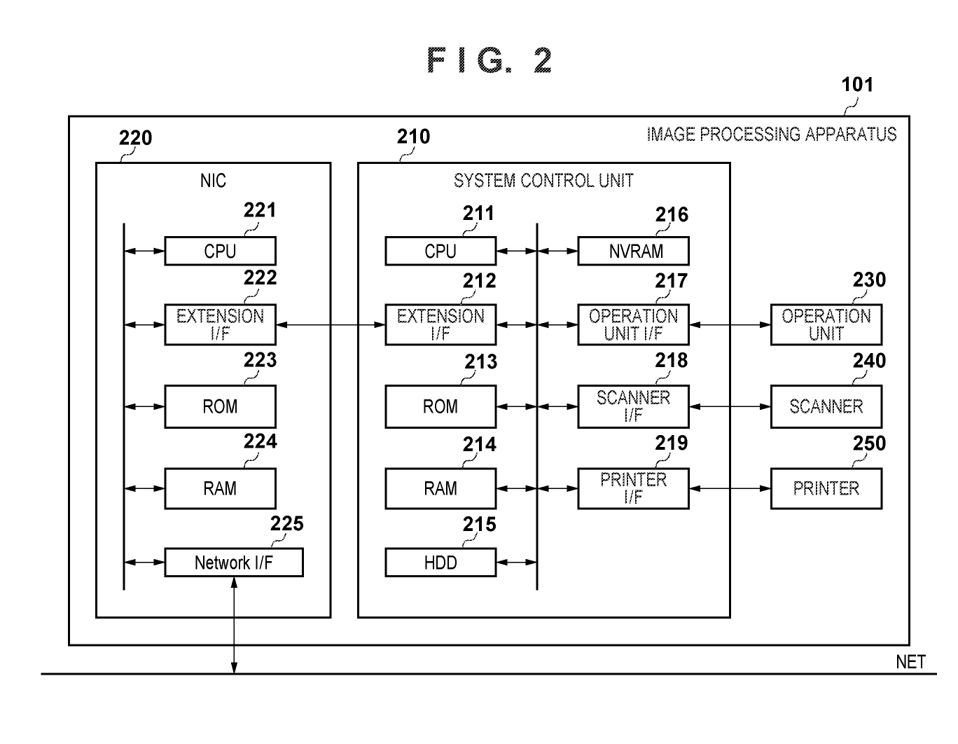

Next, an exemplary hardware configuration of the image processing apparatus 101 will be described with reference to FIG. 2. The image processing apparatus 101 includes a system control unit 210, an NIC 220, an operation unit 230, a scanner 240, and a printer 250. The system control unit 210 functions as a first control unit, and is connected to the network via the NIC 220. The system control unit 210 includes a CPU 211, an extension interface (I/F) 212, a ROM 213, a RAM 214, an HDD 215, an NVRAM 216, an operation unit I/F 217, a scanner I/F 218, and a printer I/F 219, and performs overall control of the image processing apparatus 101. The NIC 220 functions as a second control unit, includes a CPU 221, an extension I/F 222, a ROM 223, a RAM 224, and a network I/F 225, and controls only part of processing.

The system control unit 210 will now be described. The CPU 211 executes software programs in the system control unit 210 and performs overall control of the apparatus. The RAM 214 is a random access memory, and is used to temporarily store data when the CPU 211 controls the apparatus. The ROM 213 is a read only memory in which a boot program, fixed parameters and the like of the apparatus are stored.

The HDD 215 is a hard disk drive, and is used to store various types of data. The NVRAM 216 is a nonvolatile memory for storing various set values for the system control unit 210. The operation unit I/F 217 controls the operation unit 230 to cause a liquid crystal panel provided in the operation unit 230 to display various operation screens, and also transmits user instructions input through the operation screens to the CPU 211.

The scanner I/F 218 controls the scanner 240. The scanner 240 scans an image on an original to generate and output image data. The printer I/F 219 controls the printer 250. The printer 250 prints an image based on the image data on a recording medium. The extension I/F 212 is connected to the extension I/F 222 on the NIC 220 side and controls data communication with external apparatuses (such as the PC 102) on the network via the NIC 220.

The following describes the NIC 220. The NIC 220 functions as a network interface apparatus, and the image processing apparatus 101 is connected to the network via the NIC 220. The CPU 221 executes software programs in the NIC 220 and performs overall control of the apparatus. The RAM 224 is a random access memory, and is used to temporarily store data when the CPU 221 controls the apparatus. The ROM 223 is a read only memory in which a boot program, fixed parameters and the like of the apparatus are stored.

The extension I/F 222 is connected to the extension I/F 212 on the system control unit 210 side and controls data communication between the system control unit 210 and the NIC 220. The network I/F 225 is connected to the network and controls data communication between the NIC 220 (and the system control unit 210 and the image processing apparatus 101) and an external apparatus (PC 102) on the network.

According to the present embodiment, the system control unit 210 can switch between a normal power mode (first power mode) and a power saving mode (second power mode) in which power consumption is lower than the normal power mode, to operate. When the system control unit 210 shifts from the normal power mode to the power saving mode, the supply of power to, for example, the CPU 211, the HDD 215, and the NVRAM 216 is stopped. On the other hand, the NIC 220 operates with an application specific integrated circuit (ASIC) different from that of the system control unit 210. Therefore, even in a state in which the system control unit 210 has shifted to the power saving mode, the supply of power to the NIC 220 continues and realizes a proxy response function described later. In other words, in the present embodiment, power is supplied to all the components in the normal power mode, whereas power is supplied to only the NIC 220 in the power saving mode.

Software Configuration of Image Processing Apparatus

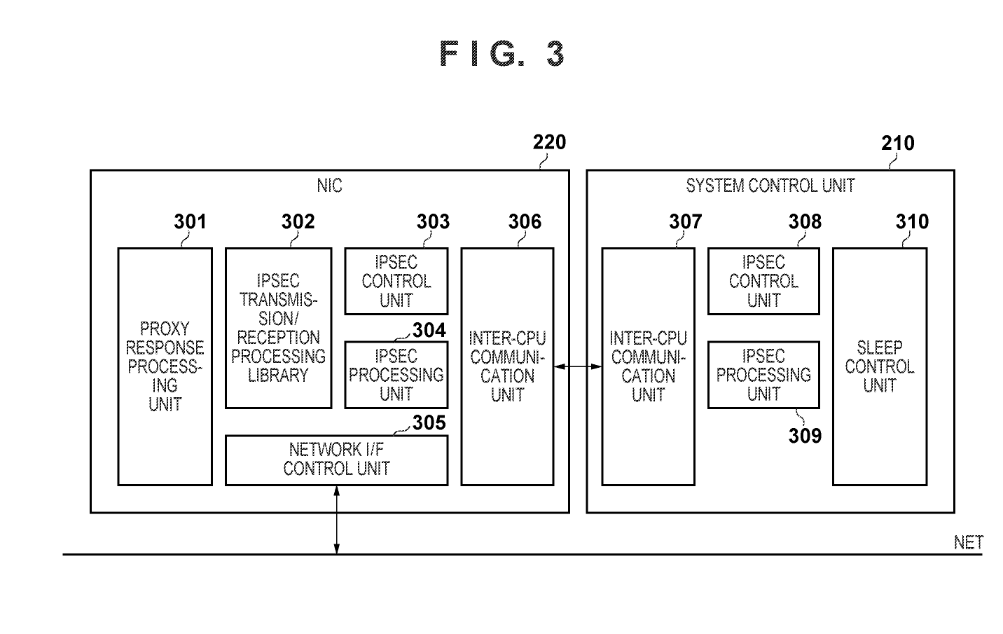

Next, an exemplary software configuration of the image processing apparatus 101 will be described with reference to a block diagram in FIG. 3. In terms of software configuration, the system control unit 210 includes an inter-CPU communication unit 307, an IPsec control unit 308, an IPsec processing unit 309, and a sleep control unit 310 as shown in FIG. 3. The NIC 220 includes a proxy response processing unit 301, an IPsec transmission/reception processing library 302, an IPsec control unit 303, an IPsec processing unit 304, a network I/F control unit 305, and an inter-CPU communication unit 306.

First, the software configuration of the system control unit 210 will be described. The sleep control unit 310 performs control of switching between the normal power mode and the power saving mode. The IPsec processing unit 309 performs, for example, negotiation processing for acquiring information necessary to execute IPsec communication, and encryption/decoding processing of packets exchanged with an external apparatus.

The IPsec control unit 308 controls the IPsec processing unit 309, and also holds information required when the IPsec processing unit 309 performs processing regarding IPsec. The inter-CPU communication unit 307 performs transmission/reception of data with software components operating on the NIC 220 via the extension I/F 212 and the extension I/F 222. The inter-CPU communication unit 306 also performs transmission/reception of data with software components operating on the system control unit 210 via the extension I/F 222 and the extension I/F 212.

Next, the software configuration of the NIC 220 will be described. The IPsec processing unit 304 performs encryption/decoding processing on packets exchanged with an external apparatus. Note that although, unlike the IPsec processing unit 309, the IPsec processing unit 304 is not configured to perform negotiation processing for acquiring information necessary to execute IPsec communication, the IPsec processing unit 304 may have the same configuration as the IPsec processing unit 309. The IPsec control unit 303 controls the IPsec processing unit 304, and also holds information required when the IPsec processing unit 304 performs processing regarding IPsec.

The network I/F control unit 305 controls transmission/reception of packets via the network I/F 225. Note that the network I/F control unit 305 always understands whether the system control unit 210 is operating in the normal power mode or the power saving mode. When the system control unit 210 is operating in the normal power mode, the network I/F control unit 305 transfers a packet received from the network to the system control unit 210. When the system control unit 210 is operating in the power saving mode, the network I/F control unit 305 transfers a packet received from the network to the IPsec processing unit 304.

The proxy response processing unit 301 receives a reception packet transferred from the IPsec processing unit 304. Since the IPsec processing unit 304 receives packets only when the system control unit 210 is operating in the power saving mode, the proxy response processing unit 301 also operates in only this case. The IPsec transmission/reception processing library 302 performs encryption/decoding processing as necessary on the packets passed from the proxy response processing unit 301, and outputs the encrypted/decoded packets.

The proxy response processing unit 301 classifies received packets into three types, namely, “packets to be discarded”, “packets to be transferred to the system control unit 210”, and “packets to be responded to by a proxy”. “Packets to be discarded” refers to packets that can be ignored (no need to respond) because, for example, these packets are not destined for its own apparatus. If classified into this category, the received packets are discarded.

“Packets to be transferred to the system control unit 210” refers to packets that require some processing that cannot be performed by only the NIC 220. If such packets have been received, the proxy response processing unit 301 causes the system control unit 210 to revert from the power saving mode to the normal power mode, and transfers received packets to the system control unit 210. “Packets to be responded to by a proxy” refers to packets to which the NIC 220 returns responses as a proxy of the system control unit 210. In this case, the proxy response processing unit 301 encrypts packets to be transmitted as responses before transmission, using the IPsec transmission/reception processing library 302.

Security Association Database

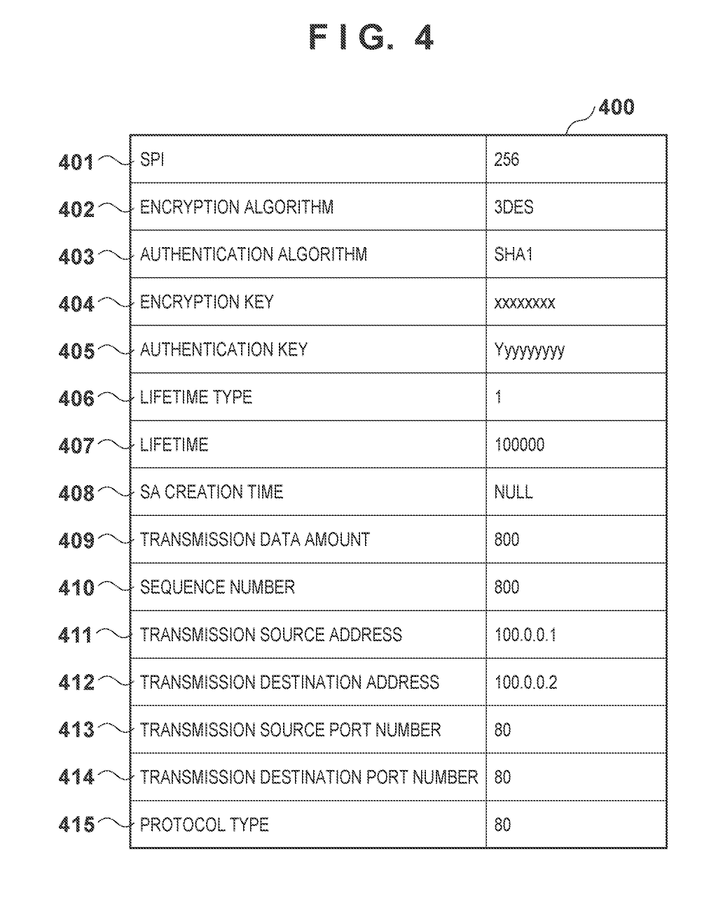

Next, a security association database (SAD) stored in the RAM 214 of the system control unit 210 and the RAM 224 of the NIC 220 will be described with reference to FIG. 4. The SAD is a database that holds security association (SA) information. The SA information refers to unidirectional traffic information in IPsec communication (security communication) with a predetermined party (external apparatus). The SAD is generated by each of the IPsec control units and has set therein the SA information that is determined by the IPsec control unit conducting negotiations with an external apparatus.

As shown in FIG. 4, an SAD 400 has defined therein information including a security parameter index (SPI) 401, an encryption algorithm 402, an authentication algorithm 403, an encryption key 404, an authentication key 405, a lifetime type 406, a lifetime 407, an SA creation time 408, a transmission data amount 409, a sequence number 410, a transmission source address 411, a transmission destination address 412, a transmission source port number 413, a transmission destination port number 414, and a protocol type 415. The SPI 401 is a value for identifying each piece of SA information. The encryption algorithm 402 indicates the type of the encryption algorithm used in this traffic. The authentication algorithm 403 indicates the type of the authentication algorithm used in this traffic.

The encryption key 404 indicates key information to be used when encrypting this traffic. The authentication key 405 indicates key information to be used when authenticating this traffic. The lifetime type 406 indicates whether the time from when the SA information has been created (in units of seconds) or the amount of data transmitted (in units of kilobytes) is used as the term of validity of the SA information. The lifetime 407 indicates the actual value of the lifetime of the SA information.

The SA creation time 408 indicates the time when the SA information has been created (seconds elapsed since the startup of the system), and is used to determine the validity of the SA information when the “time” is set in the SA lifetime type 406. The transmission data amount 409 indicates the amount of data transmitted since the creation of the SA information, and is used to determine the validity of the SA information when the “data amount” is set in the SA lifetime type 406. The sequence number 410 indicates a value for avoiding replay attacks, which is set in the IPsec header and incremented by one every time a packet has been transmitted.

The transmission source address 411 indicates a transmission source IP (IPv6) address of IPsec traffic associated with the SA information. The transmission destination address 412 indicates a transmission destination IP (IPv6) address of the IPsec traffic associated with the SA information. The transmission source port number 413 indicates the port number of the transmission source of the IPsec traffic associated with the SA information. The transmission destination port number 414 indicates the port number of the transmission destination of the IPsec traffic associated with the SA information. The protocol type 415 indicates the protocol type of the IPsec traffic associated with the SA information.

Shift-to-Sleep Processing

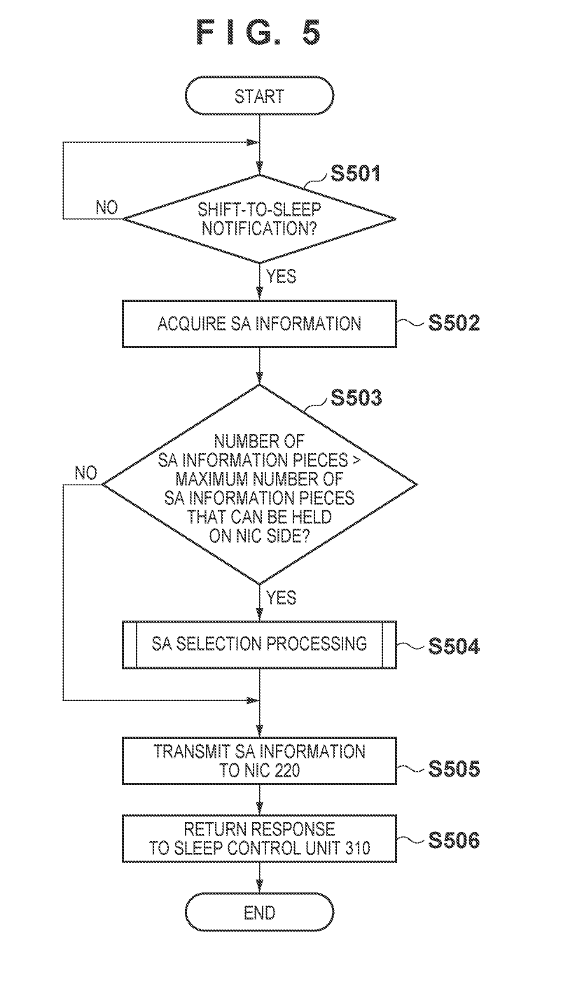

Next, the procedure of processing performed by the system control unit 210 when shifting to the sleep state will be described with reference to FIG. 5. The processing described below is realized by the CPU 211 loading a control program stored in the ROM 213, the HDD 215 or the like into the RAM 214 and executing that program.

First, in step S501, the IPsec control unit 308 periodically monitors whether a shift-to-sleep notification has been received from the sleep control unit 310. The “shift-to-sleep notification” as used herein refers to a notification issued from the sleep control unit 310 when the system control unit 210 has shifted from the normal power mode to the power saving mode. If the shift-to-sleep notification has been received from the sleep control unit 310, the procedure proceeds to step S502, in which the IPsec control unit 308 acquires SA information pieces corresponding to all IPsec sessions stored in the RAM 214.

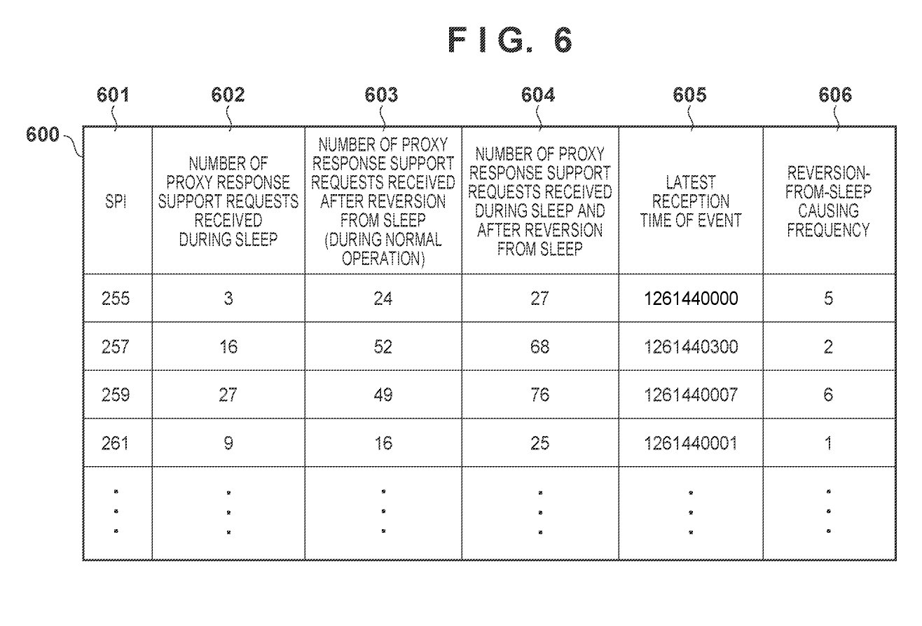

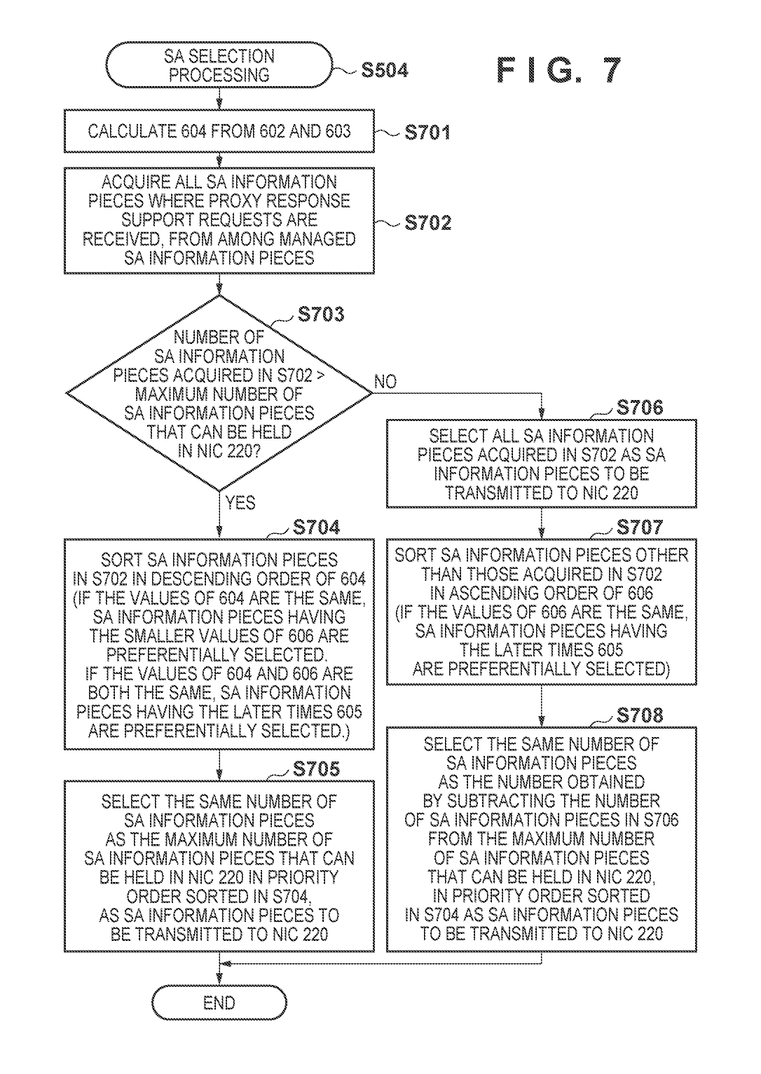

Next, in step S503, the IPsec control unit 308 compares the number of SA information pieces acquired and a maximum number of SA information pieces that can be held in the NIC 220. If the maximum number of SA information pieces that can be held in the NIC 220 is greater than or equal to the number of SA information pieces acquired, the IPsec control unit 308 advances the procedure to step S505. On the other hand, if the maximum number of SA information pieces that can be held in the NIC 220 is smaller than the number of SA information pieces acquired, it is impossible to pass all the SA information pieces held on the system control unit 210 side to the NIC 220 side, due to resource limitations. Thus, in step S504, the IPsec control unit 308 selects SA information pieces to be passed to the NIC 220 from among the acquired SA information pieces, and thereafter the procedure proceeds to step S505. The processing for selecting SA information pieces will be described in detail later with reference to FIGS. 6 and 7.

In step S505, the IPsec control unit 308 transmits all the SA information pieces or the selected SA information pieces to the NIC 220 side via the inter-CPU communication unit 307. Subsequently, in step S506, the IPsec control unit 308 returns a response to the above shift-to-sleep notification to the sleep control unit 310, upon which the sleep control unit 310 performs shift-to-sleep processing, and thereafter the processing ends.

Processing for Selecting SA Information

The following describes the processing for selecting SA information pieces with reference to FIGS. 6 and 7. First, an SA selection table to be used as a judgment criterion when the IPsec control unit 308 performs the SA-information selection processing in step S504 in FIG. 5 will be described with reference to FIG. 6. This SA selection table 600 is stored in, for example, the HDD 215. The IPsec control unit 303 and the IPsec control unit 308 each manage the SA selection table by updating this table at the time of reversion from the sleep state and at the time of shift to the sleep state, and use this table as a judgment criterion for performing the SA selection processing.

Reference numeral 601 shown in FIG. 6 denotes SPI data, which is the same as the SPI 401. The IPsec control unit 308 manages an individual SA information piece and the SA selection table for each SPI. The SA selection table defines information pieces described below in association with the respective SPIs 601. Reference numeral 602 denotes count information indicating the number of times that a request for which proxy response is supported by the NIC 220 (proxy response support request) has been received from the external apparatus during sleep (during the power saving mode). The IPsec control unit 303 counts, for each SPI, the number of receptions 602 of proxy response support requests during sleep.

Reference numeral 603 denotes count information indicating the number of times that a request for which proxy response is supported by the NIC 220 has been received from the external apparatus after reversion from the sleep state, that is, during normal operation (during the normal power mode). The IPsec control unit 308 counts, for each SPI, the number of receptions 603 of proxy response support requests during normal operation. Reference numeral 604 denotes a total value of the value 602 and the value 603. At the time of reversion from the sleep state, the IPsec control unit 308 acquires the number of receptions 602 of proxy response support requests during sleep, from the IPsec control unit 303. The IPsec control unit 308 can also acquire the total value 604 by adding the number of receptions 603 of proxy response support requests during normal operation, which is held by itself at the time of the shift to the sleep state, and the acquired number of receptions 602 of proxy response support requests during sleep. It is possible to determine that the greater the value of the number of receptions 604 the SPI has, the greater the number of times the SPI has received proxy response support requests from the external apparatus.

Reference numeral 605 denotes information indicating the latest time of reception of a proxy response support request from an external apparatus. This value is constantly updated at the time of reception of a proxy response support request from an external apparatus by the IPsec control unit 303 during sleep and by the IPsec control unit 308 during normal operation. Reference numeral 606 denotes count information indicating the number of times that a packet that causes reversion from the sleep state has been received (reversion-from-sleep causing frequency), for each individual SPI 601. It is possible to determine that the greater the reversion-from-sleep causing frequency 606, the higher the possibility of occurrence of reversion from the sleep state, i.e., reversion from the power saving mode to the normal power mode in IPSec communication based on the SPI 601.

Next, the procedure of the SA selection processing shown in step S504 in FIG. 5 will be described in detail with reference to FIG. 7. The processing described below is realized by the CPU 211 loading a control program stored in the ROM 213, the HDD 215 or the like into the RAM 214 and executing that program.

First, in step S701, the IPsec control unit 308 calculates the number of receptions 604 for each SPI 601 from the number of receptions 602 of proxy response support requests during sleep and the number of receptions 603 of proxy response support requests during normal operation, both of the numbers being acquired from the SA selection table. Subsequently, in step S702, the IPsec control unit 308 acquires all SA information pieces where proxy response support requests are received, from among the SA information managed by the IPsec control unit 308 itself. In step S703, the IPsec control unit 308 determines whether or not the number of SA information pieces acquired in step S702 exceeds the maximum number of SA information pieces that can be held in the NIC 220.

If the number of SA information pieces acquired in step S702 exceeds the maximum number of SA information pieces that can be held in the NIC 220, the procedure proceeds to step S704, in which the IPsec control unit 308 sorts the SA information pieces that have been acquired in step S702 in descending order of the number of receptions 604, and then preferentially selects SA information pieces having the larger number of receptions 604. Here, if SA information pieces have the same value of the number of receptions 604, those having the smaller value of the reversion-from-sleep causing frequency 606 will be preferentially selected. Furthermore, if SA information pieces have the same values for both the number of receptions 604 and the reversion-from-sleep causing frequency 606, those having the later time of reception 605 of a proxy response support request will be preferentially selected. In step S705, the IPsec control unit 308 selects, as SA information pieces to be transmitted to the NIC 220, the same number of SA information pieces as the maximum number of SA information pieces that can be held in the NIC 220 in descending order of the values sorted in step S704, and thereafter the procedure ends.

The above processing in step S704 is merely an example, and is not intended to limit the present invention. The IPsec control unit 308 may select SA information pieces by combining selection conditions described below or by applying these conditions individually. Specifically, the IPsec control unit 308 may preferentially select SA information pieces having the greater total values of the number of receptions 602 and the number of receptions 604. The IPsec control unit 308 may also preferentially select SA information pieces having the greater numbers of receptions 602. Furthermore, the IPsec control unit 308 may preferentially select SA information pieces having the lower reversion-from-sleep causing frequencies 606. The IPsec control unit 308 may also preferentially select SA information pieces having the later reception times 605. Alternatively, the IPsec control unit 308 may select SA information pieces by combining the above-described selection conditions. Furthermore, these selection conditions may be set by the operator through the operation unit 230.

On the other hand, in step S703, if the number of SA information pieces acquired in step S702 is smaller than or equal to the maximum number of SA information pieces that can be held in the NIC 220, the procedure proceeds to step S706, in which the IPsec control unit 308 selects all the SA information pieces acquired in step S702 as SA information pieces to be transmitted to the NIC 220. In step S707, the IPsec control unit 308 sorts the remaining SA information pieces other than those acquired in step S702 in ascending order of the reversion-from-sleep causing frequencies 606. Here, if SA information pieces have the same value of the reversion-from-sleep causing frequency 606, those having the later reception times 605 of a proxy response support request will be preferentially selected. In step S708, the IPsec control unit 308 additionally selects the same number of SA information pieces as a difference that is obtained by subtracting the number of SA information pieces selected in step S706 from the maximum number of SA information pieces that can be held in the NIC 220, in ascending order of the values sorted in step S707, as SA information pieces to be transmitted to the NIC 220.

Through this, it is possible to receive more proxy response support requests, receive fewer requests causing reversion from the sleep state, and preferentially transmit, to the NIC 220, SA information pieces where proxy response support requests have more recently been received. During sleep, if a proxy response support request has been received, the IPsec control unit 303 constantly updates the number of receptions 602 of proxy response support requests and the latest reception time 605 for each SPI 601. Furthermore, if a request causing reversion from the sleep state has been received, the IPsec control unit 303 specifies the SPI 601 that is the cause of reversion from the sleep state and updates the reversion-from-sleep causing frequency 606.

Reversion-from-Sleep Processing

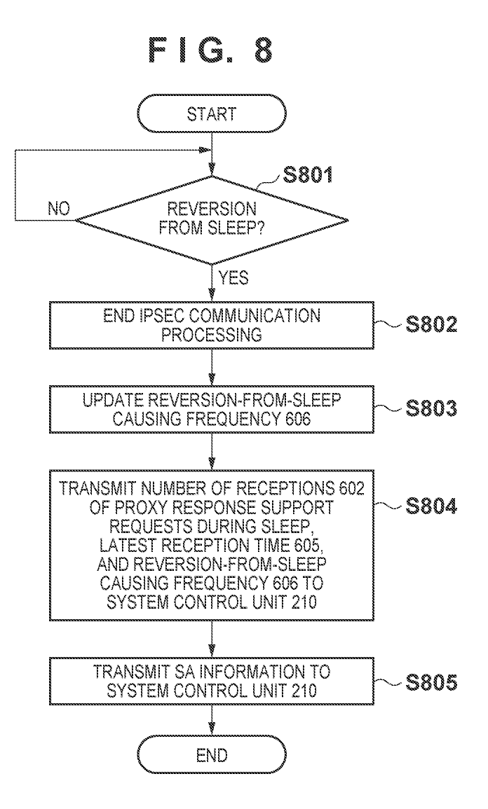

Next, the procedure performed at the time of reversion from the sleep state will be described with reference to FIG. 8. Although there are several types of triggers for reversion from the sleep state, the case where a reversion-from-sleep packet has been received via the network and the case where reversion from the sleep state is caused upon reception of a packet that does not correspond to the SA information regarding IPsec are described here as exemplary embodiments. The processing described below is realized by the CPU 221 loading a control program stored in the ROM 223 or the like into the RAM 224 and executing that program.

When the NIC 220 has received a reversion-from-sleep packet, in step S801, the IPsec control unit 303 decodes the IPsec packet received from the external apparatus using the IPsec processing unit 304 and the IPsec transmission/reception processing library 302. The IPsec control unit 303 checks whether or not the decoded packet is a reversion-from-sleep causing packet. If the packet is not a reversion-from-sleep causing packet, the proxy response processing unit 301 performs, for example, processing for returning a proxy response or processing for discarding the received packet, details of which are, however, not related to the present patent and thus have not been described here. If reversion from the sleep state is caused upon reception at the NIC 220 of a packet that does not correspond to the SA information regarding IPsec, decoding processing is not performed.

Next, in step S802, the IPsec control unit 303 requests the IPsec processing unit 304 to end IPsec communication. Upon reception of this request, the IPsec processing unit 304 will complete the IPsec communication processing during execution. Through this, the IPsec processing unit 304 brings the NIC 220 into a state in which no packets are during encryption/decoding processing. In step S803, the IPsec control unit 303 determines the SA information piece that corresponds to communication through which a request causing reversion from the sleep state has been received, and updates the value of the reversion-from-sleep causing frequency 606 for the corresponding SPI 601.

Then, in step S804, the IPsec control unit 303 creates update information including the number of receptions 602 of proxy response support requests during sleep, the latest reception time 605, and the reversion-from-sleep causing frequency 606, which are managed for each SA information piece, and transmits the update information to the system control unit 210 side via the inter-CPU communication unit 306. On the system control unit 210 side, the IPsec control unit 308 receives this information and updates data in the SA selection table for each individual SPI.

In step S805, the IPsec control unit 303 transmits all the SA information pieces held and managed by itself to the system control unit 210 side via the inter-CPU communication unit 306. On the system control unit 210 side, the IPsec control unit 308 updates the SA information pieces held by the system control unit itself, with all the received SA information pieces. This makes it possible to resume IPsec communication by carrying over the SA information pieces regarding the IPsec communication performed during sleep, after reversion from the sleep state. During normal operation after the reversion-from-sleep processing, the IPsec control unit 308 constantly updates, for each SA, the number of receptions 603 of proxy response support requests when a proxy response support packet has been received, and also performs processing for updating the latest reception time 605.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-095279 filed on Apr. 21, 2011, which is hereby incorporated by reference herein in its entirety.

What is claimed is:

1. An image processing apparatus connected to a network via a network interface apparatus and capable of operating in either a first power mode or a second power mode in which power consumption is lower than in the first power mode, comprising:
a storage unit that stores a plurality of security information pieces regarding a security communication;
a selection unit that selects a security information piece to be notified to the network interface apparatus, from among the plurality of security information pieces; and
a notification unit that notifies the network interface apparatus of the security information piece selected by the selection unit,
wherein when the image processing apparatus operates in the second power mode, the network interface apparatus executes the security communication using the security information piece notified from the notification unit.

2. The image processing apparatus according to claim 1, wherein the selection unit selects a security information piece to be notified to the network interface apparatus, based on a maximum number of security information pieces that can be held in the network interface apparatus.

3. The image processing apparatus according to claim 1, wherein the selection unit selects a security information piece to be notified to the network interface apparatus when the image processing apparatus shifts from the first power mode to the second power mode.

4. The image processing apparatus according to claim 1, wherein when the image processing apparatus shifts from the first power mode to the second power mode, the notification unit notifies the network interface apparatus of the security information piece selected by the selection unit.

5. The image processing apparatus according to claim 1, wherein
the network interface apparatus comprises:
a holding unit that holds the security information piece notified from the notification unit;
a reception unit that receives a packet from an external apparatus via the network; and
a processing unit that, when the image processing apparatus operates in the second power mode, executes either first processing or second processing based on the packet received by the reception unit, the first processing being for causing the image processing apparatus to shift from the second power mode to the first power mode, and the second processing being for giving a response to the external apparatus using the security information piece held by the holding unit.

6. The image processing apparatus according to claim 5, wherein when the processing unit executes the second processing, the image processing apparatus is not caused to shift from the second power mode to the first power mode.

7. The image processing apparatus according to claim 5, wherein the selection unit selects a security information piece to be notified to the network interface apparatus, based on the number of times that the processing unit has executed the second processing.

8. The image processing apparatus according to claim 5, wherein the selection unit selects a security information piece to be notified to the network interface apparatus, based on the number of times that the processing unit has executed the first processing.

9. The image processing apparatus according to claim 1, wherein if the number of security information pieces stored in the storage unit is greater than a maximum number of security information pieces that can be held in the network interface apparatus, the notification unit notifies the network interface apparatus of the security information piece selected by the selection unit, whereas if the number of security information pieces stored in the storage unit is less than or equal to the maximum number of security information pieces that can be held in the network interface apparatus, the notification unit notifies the network interface apparatus of all security information pieces stored in the storage unit.

10. The image processing apparatus according to claim 1, wherein
the security communication is communication based on Internet Protocol Security, and
the security information is Security Association information.

11. A control method for an image processing apparatus that is connected to a network via a network interface apparatus, is capable of operating in either a first power mode or a second mode in which power consumption is lower than in the first power mode, and includes a storage unit that stores a plurality of security information pieces regarding a security communication, the method comprising:
selecting a security information piece to be notified to the network interface apparatus, from among the plurality of security information pieces; and
notifying the network interface apparatus of the security information piece selected in the selection step,
wherein when the image processing apparatus operates in the second power mode, the network interface apparatus executes the security communication using the security information piece notified in the notification step.

12. A computer-readable storage medium storing a computer program for causing a computer to execute the steps in the control method for the image processing apparatus according to claim 11.
